(19) United States
(12) Patent Application Publication
(10) Pub. No.: US 2004/0248635 A1
(43) Pub. Date: Dec. 9, 2004

(54) Method of entertainment "Russian Poker"

(76) Inventor: Ivan Pavlovich Efremov, Moscow (RU)

Correspondence Address: FITCH EVEN TABIN AND FLANNERY, 120 SOUTH LA SALLE STREET, SUITE 1600, CHICAGO, IL, 60603-3406, US

(21) Appl. No.: 10/887,158

(22) Filed: Jul. 8, 2004

Related U.S. Application Data
(63) Continuation of application No. PCT/RU03/00321, filed on Jul. 21, 2003.

(30) Foreign Application Priority Data
Apr. 18, 2003 (RU) 2003111009

(51) Int. Cl. A63F 13/00

(52) U.S. Cl. 463/13

(57) ABSTRACT

The method of entertainment “Russian poker” is based on the popular card game and is intended for gaming halls. The game has more potential and is more absorbing because the player has the opportunity to exchange any amount of cards, insure his game, make bets on bonuses and exchange the dealer's cards. Furthermore, the player's ability to buy a sixth card and receive payment for two combinations evens out the odds for the player and casino. The use of a standard deck of cards in its gaming machines brings the game closer to reality, and allows for the exclusion of a random number generator from the machine's construction, which enhances the player's trust in the reliability of its randomness.

The present application relates to a method of entertainment including a card game and the equipment needed for this card game. The invention may be used in gaming establishments, gaming machine halls and electronic devices that use a monitor.

The method of entertainment “Russian Poker” is an adaptation of poker, one of the most popular games of chance in the 19^{th} and 20^{th} centuries, for modern casinos, gaming machines or computers.

An established method of entertainment that requires the use of a gaming table with spaces on the playing field for the implementation of bets, a deck of cards and a selection of chips of varying value to represent bets (RU 2151622, pub. 27 Jun. 2000, cl. MPK A 63 F 1/00, 1/18, 9/24, 11/00).

It is known an established method of entertainment that requires the use of a gaming table with spaces on the playing field for a deck of cards and a selection of chips of varying value (RU 2137521, pub. 20 Sep. 1999, cl. MPK A 63 F 1/00).

An established method of entertainment that uses a gaming table in the form of a half-circle with a hollow cut from the middle of the flat-edged side for the placement of a chip rack with valued chips is disclosed in RU 2139748 (pub. date 20 Oct. 1999, cl. MPK A 63 F 1/06, 1/18, 9/24). This patent also discloses the markings on the cover of the gaming table, with the definition of boxes for placing of bets and cards.

The inadequacies of many of the preceding methods of entertainment stem from the difficulty in introducing equipment to be used into gaming facilities. Conservative facilities such as casinos do not like to introduce unfamiliar games.

The analogue to the method of entertainment “Russian Poker” is the “game of poker”, based on the popular card game, which uses a standard card table in the form of a half-circle with a hollow cut from the middle of the flat-edged side for the placement of a chip rack with valued chips. The “game of poker” uses a cover on the game table with spaces for the game field, a standard deck of cards and valued chips of varying worth (U.S. Pat. No. 4,836,553, Jun. 6, 1989, Int. Cl. A63 F 1/00, US Cl. 273/292; 273/274).

The analogy to the “game of poker” is imperfect, however, discounting this method of entertainment's appeal, because it is impossible in the “game of poker” for the player to change cards or choose playing combinations on his own. In order to win in that game, the player can't count on his mind, only on his luck.

An established electrical gaming machine that relates to entertainment and card games is disclosed in RU 2060756 (published 27 May 1996, cl. MPK A 63 F9/22, G 07 F 17/32).

The inadequacy of gaming machines based on receiving winning combinations stems from the use of a random number generator in the machine, which creates a chance for the player to question the reliability of its randomness. Players would prefer to play with a machine in which a traditional deck of cards was used in the place of a random event generator.

An established strategic computer game comprises a computer with a monitor and with the means to load information from the user of the computer system and the means of displaying an array of elements on the screen (RU 2099782, pub. 20 Dec. 1997, cl. MPK G 06 F 19/00, G 06 F 161:00). The method of displaying the computer game to the player, in which the playing field is projected onto the monitor, is also described in this source.

An established method of conducting electronic games for money bets using an electronic device with a monitor is described in RU 2162359 (published 27 Jan. 2001, cl. MPK A 63 F 9/24, A 63 F 13/10, G 06 F 17/00).

The inadequacy of already existing computer games and similar playing machines stems from the small degree of their compelling qualities and the difficulty using these games in a local or global set.

The technical results of the proposed application enhance the functional capabilities and absorbing qualities of the game. By simply re-equipping a typical playing table for the method of entertainment “Russian Poker”, placing a cover on a table with the outlines of the playing field for this game, a casino can to broaden the assortment of games available to its clients. Furthermore, the popularity of poker in all countries increases the prospects of its widespread distribution.

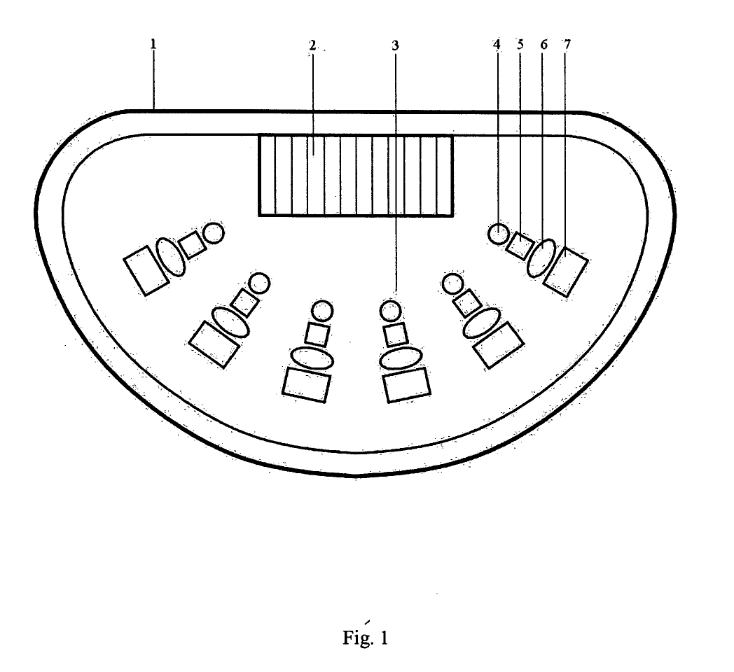

The method of entertainment, as is shown in FIG. 1, uses a gaming table 1, a chip holder 2, a table's cover with the outline of the playing field, the chips and a deck of cards, in which one or several players make cash bets using chips.

The minimum bet and maximum payout for a winning combination is displayed on a tablet on the playing table, but there is no limit to the maximum bet.

The players' places are marked on the gaming table's cloth cover 3 and each place consists of four geometrical shapes:

a circle 4 for chips to make purchases and for a token with the number 6;

a square 5 for betting on the bonus and placing chips used to make an exchange or to buy insurance;

an ellipse 6 for the initial bet;

a rectangle 7 for the player's cards and for doubling bets.

One player can play on two spaces by making two bets on two square figures used for the game on the bonus and/or two equal initial bets on the ellipse figures, in which case he will receive two hands of five cards each. The minimum size and the size of the maximum payout for the bets on the bonus, if those are made without an initial bet, remains equal to the limits placed on regular bets at said table.

The game uses two decks of 52 cards, consisting of 4 suits of 13 cards each. The dealer shuffles the deck of cards 2-3 times, cuts the deck, shuffles it another 2-3 times and then gives it to one of the players to cut. The dealer deals five cards each to all the players, himself included, and the last card that goes to the dealer is dealt face-up.

The bet on the bonus, located on the square, pays out when there is a combination in the player's initial hand of a three-of-a-kind or higher, regardless of the playing combination in the dealer's hand. Players who receive chips from a winning bet on the bonus can exchange any number of his five cards or buy a sixth card for the sum of his initial wager.

At first, the players must make the decision about which cards from their first hand to exchange, and only then can they look at the cards of the second hand.

To exchange 1, 2, 3, 4 or all 5 cards, the players place the cards to be exchanged into the square together with a sum equal to their initial wagers. In order to buy a sixth card, the players place that same sum in the circle. The dealer removes the chips from the circle, and places a token with the number 6 in their place and gives the player a sixth card.

When there aren't enough cards for the next exchange, the dealer shuffles the cards that have already been discarded from the game and continues the exchange with those cards.

Players with three-of-a-kind or higher can insure themselves by placing the insurance sum in the square to protect against the absence of a playing combination in the dealer's hand. The sum must be within the parameters of the anticipated winnings.

When the players have made all their decisions about strengthening their hands, the dealer compares the players' hands and his hand in order and determines the winning or losing wagers.

If the dealer doesn't have a playing combination, the player is paid winnings equal to the size of his insurance sum. If the dealer's hand is weaker than the player's, the player loses the insurance sum, and if the dealer's hand is stronger, the insurance sum is returned to the player.

If the dealer doesn't have a playing combination, the players receive their initial bet or, if they pay that sum, placing it on the ellipse, they may exchange one of the dealer's old cards for a new card from the deck. If the dealer still doesn't have a playing combination after the exchange, the initial bet is not returned or paid. If the new card is the same value as the exchanged one after the card exchange, and the dealer still doesn't have a playing combination, the player can repeat the exchange. If the dealer has a stronger hand than the player after the exchange, the player loses only the doubled bet that was placed on the rectangle.

If the dealer has a weaker playing combination than the player, the player is paid the winning bet in accordance to the strength of the winning hand. The payout of the player's winnings is based only on the chips placed on the doubled bet, placed on the rectangle, and takes all the fully developed combinations in the player's hand into account, in proportion to the corresponding strength of the playing combination and the table of payouts. If, in addition to the winning combination, there is a second winning combination in the player's hand, it also gets paid. The second winning combination must include at least one card that wasn't part of the primary winning combination. No more than two playing combinations may win in a player's hand.

If the casino isn't a part of the game, and the dealer only shuffles and deals the cards, enforces the rules and collects a commission, then the table may be prepared in the shape of an oval 8 (FIG. 3). In this case, the players' places with four geometric figures for bets are spread across the cloth table cover in a semicircle. If the casino is not taking part in the game, one of the players may be the dealer or, if there are multiple players that want to be dealer, the position can rotate among them.

The principal innovation of “Russian Poker”, and what differentiates it from other casino and electronic games, is its mathematical basis, which in turn allows for the use of paper or plastic cards in the playing machine. According to the rules of the game for “Russian Poker”, the player has even chances to win against the casino or gaming machine: 50/50. Only inaccuracy on the player's part when making decisions will bring the gaming establishment profits. This would be a first in the gaming business.

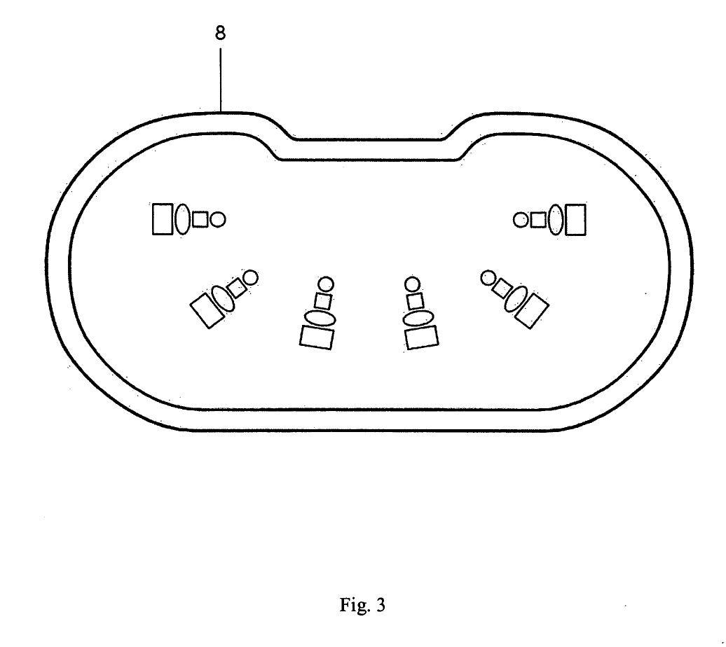

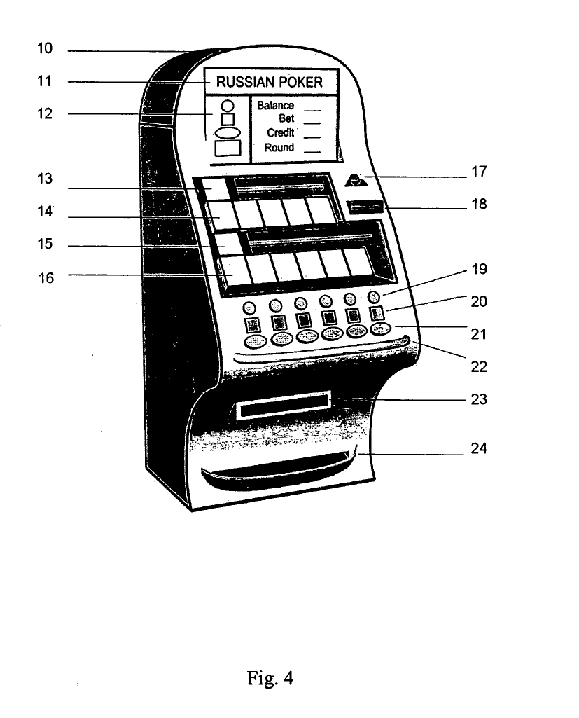

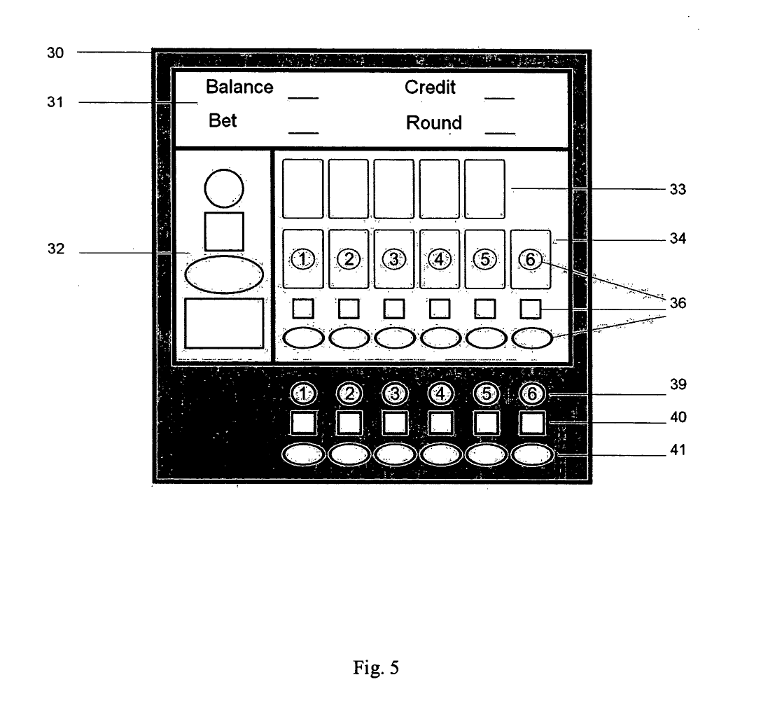

These advantages and prospects mean that that the method of entertainment can exist with the help of a playing machine 10 (FIG. 4) that comprises electronic equipment, a computer that directs the sequence of the machine actions and corresponding winning and losing wagers, a monitor 11 (FIG. 5) for showing the balance and the turn of the game, a playing panel 19 with command keys 19, 20 and 21, and a slot for tokens 24 and currency 23 that can calculate their size, value and number, adapting for the subsequent payout of tokens (FIG. 4-24) and cash (FIG. 4-23).

The machine uses decks of paper or plastic cards, consisting of 52 cards with four suits of 13 cards each for the game. Two decks of cards are used so that the game will be played more quickly. While a player is playing the game, the machine shuffles the second deck.

There is a control panel with 3 rows of functional keys for transferring the corresponding command into the electronic device.

In the bottom row 21 (FIG. 4):

“Game”—for beginning the game, and for pausing the game by pressing it again

“Bonus”—for placing a bet on the bonus, equal to the initial bet

“Increase”—for decreasing the sum of the bet or the insurance

“Decrease”—for increasing the sum of the bet or the insurance

“Cancel”—for canceling the last bet

“Payout”—for receiving the remaining balance

In the middle row 20 (FIG. 4):

“Repeat”—for repeating the bet placed in the previous round of the game

“Exchange”—for confirming the exchange of the cards chosen by the player

“Dealer's Game”—for exchanging one of the electronic dealer's cards

“Bet”—for receiving the initial bet

“Insurance”—for purchasing insurance against the absence of a playing hand for the dealer

“Refuse”—for turning down an offer for insurance

In the top row 19 (FIG. 4) of the machine panel, there is a button under each card in the player's hand labeled from “1” to “5” for selecting the cards to be exchanged and a button with the number “6” for the purchase of a sixth card.

There is an arm rest 22 (FIG. 4) on the machine panel, below the keys, to be used during the game as an arm support, and it may be adjusted by several centimeters, according to the player's preferences.

The minimum bet and maximum payout for a winning combination are posted on the gaming machine monitor, but there is no limit to the size of a bet. There is a status bar on the monitor, which shows how much credit the player has, as well as the balance from the beginning of the game and the results of both the last round and the current round. Four figures—a circle, a square, an ellipse and a rectangle—are displayed on the screen 12 (FIG. 4), showing the bets the player has made. At the beginning of every turn of the game, the monitor displays the highest combination of cards in the player's hand for his information.

A card-shuffling mechanism is used in order to insure the random placement of the cards in the machine.

Inside the machine, behind a transparent screen, there are two rows of bins, each bin the size of a card. There are 5 bins for the machine hand 14 (FIG. 4) and below that are 6 bins for the player's hand 16. There also is a card-distributing mechanism that consists of two trays for the cards and moves with the help of a belt. The lower tray 15 (FIG. 4) distributes cards in 5 of the 6 bins for the player's hand.

In the top tray 13, the machine five cards remain hidden, and the player can only see the first, face-up card.

The machine pays out wagers on the bonus whenever the player's combination of cards is three-of-a-kind or higher, regardless of strength of the gaming machine hand. After the player receives his winning bonus, he may continue the current round of play.

For a sum equal to the initial bet the machine will exchange 1, 2, 3, 4 or 5 of the player's cards or add a sixth card to the player's five.

In order to exchange cards, the player uses the five keys located on the machine front panel under each of the player's five cards, or the sixth key to signify that he is buying a sixth card. By pressing the corresponding keys on the machine panel, the player shows which cards he wants to exchange and then presses the “Exchange” button, paying a stake the size of the initial bet. The card-distributing mechanism places the new cards from the shuffling mechanism into the player's tray and from there places the cards in the player's bins, covering the cards that the player had selected with their substitutions. By pressing the sixth button, the player purchases a sixth card, and it is placed in the player's tray and moved into the empty sixth bin.

Even if the player's hand has a high playing combination, it is necessary for the machine to also have a game in order for the player to receive the winnings. For that reason, the players can insure themselves in case of the absence of a playing combination in the machine hand, designating an amount of chips for the insurance sum that is no higher than the anticipated winnings of the hand. If there isn't a playing hand in the machine cards, then the machine pays the player the insurance sum. If there is a playing combination, the insurance sum is lost, but the initial bet wins.

After the player has made all the decisions about strengthening his hand and buying insurance, the card-distribution mechanism turns over the cards in the second tray into the five bins of the top row, symbolizing the machine hand. To compare the two hands, in the top and bottom rows, a logical optical system determines the suits and value of the cards.

The winning hand is determined using the help of the controlling computer and, if it is the player's hand, pays out his winnings, changing the data on the status bar on the machine monitor. When the player wins, the machine pays out only the doubled bet in proportion to the corresponding strength of the winning combination and the table of payouts. However, it also pays out if there is a second winning combination in the player's hand, provided that combination has at least one card that was not included in the primary winning combination.

If the player has a high winning combination but the machine hand of cards doesn't have a playing combination, the players may press the “Dealer's Game” button and, paying their initial bet, exchange the senior card in the machine hand for a new one.

The machine accompanies the game with musical melodies, sounds and video effects.

The machine may be prepared for several players playing at once, in which case ever player has his own display and command keys, while the playing combinations in the players' hands are compared with the playing combination in the machine hand alone.

The method of entertainment “Russian Poker” created with the help of an electronic device with a monitor allows for the possibility of its user to play in a place that is comfortable for him. It calls for the use of a random number generator in the electronic device, which does not rely on the help of programming methods, and thereby influences the believability of the player's winnings. Its application in games together with other players can be increased by using the method of entertainment on a local set or on the internet.

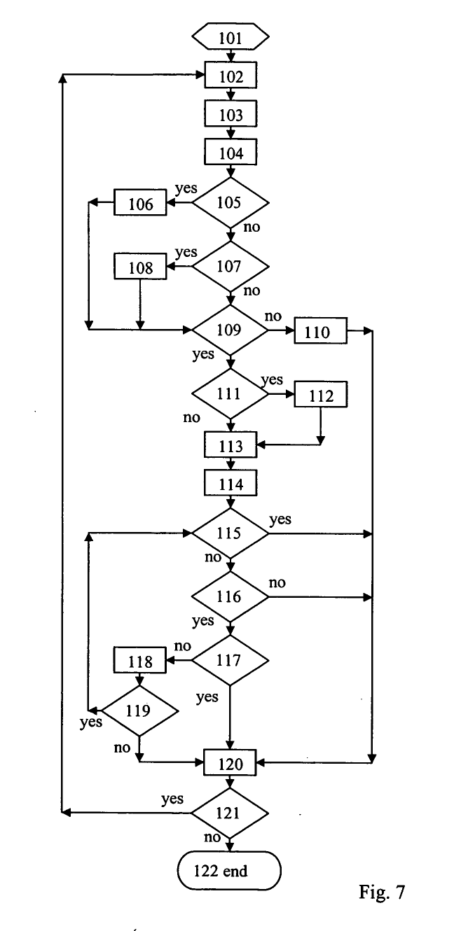

These goals for the method of entertainment are achieved by an embodiment shown in FIG. 5, which is an electronic device with a monitor, used to conduct, based on data analysis, the realization of the entered commands via a computer program that is founded on the algorithm of the game (FIG. 7). An image of the playing field, chips and electronic playing cards 3 are formulated on the display. There are four FIG. 32 in the image—a circle, a square, an ellipse and a rectangle, which represent the bets placed by the player. A random number generator is used to ensure the random order of the electronic cards in the device. The electronic device shows the minimum wager and the maximum payout allowed for a winning combination, but the maximum bet is not limited.

There are three rows of functional buttons to conduct the corresponding commands from the command panel into the electronic device.

In the bottom row 41 (FIG. 5):

“Game”—for beginning the game and for pausing the game by pressing it again

“Bonus”—for placing a bet on the bonus, equal to the initial bet

“Decrease”—for decreasing the sum of the bet or insurance

“Increase”—for increasing the sum of the bet or insurance

“Cancel”—for canceling the last bet

“Payout”—for receiving the remaining balance

In the middle row 40:

“Repeat”—for repeating the bet from the previous round of the game

“Exchange”—for confirmation of the exchange of the cards chosen to the player

“Dealer's Game”—for exchanging the cards of the electronic dealer

“Bet”—for receiving the initial bet

“Insurance”—for insuring against the absence of a playing hand for the dealer

“Refuse”—for turning down an offer for insurance

In the top row 39 of the machine panel, there is a button under each card in the player's hand labeled from “1” to “5” for selecting the cards to be exchanged and a button with the number “6” for the purchase of a sixth card.

On the monitor, below the player's cards, there is the image of the three rows of control buttons with the name of the respective function on each of them 36. These buttons, which may be used at any moment of the game, become brighter so as to help the player make this or that playing decision.

For each move in the game, the electronic device formulates a status bar on the monitor, which shows the current balance of the game, as well as the sum won or lost from the beginning of the game and the results of both the previous and current round of the game. The electronic device, using a random number generator, formulates the image of two hands of cards, representing the hands of the electronic dealer and the player, on the screen.

Both the minimum size of the bet on the bonus (excluding the initial bet) and the size of the maximum payout are the same as the regular bet on the given electronic device. The electronic device pays out bets on the bonus when the combination in the player's initial hand is a three-of-a-kind and higher, regardless of strength of the electronic dealer's hand.

For a sum equal to the initial bet, the player can pay to exchange any amount of his cards, and the electronic device exchanges the cards indicated by the player for new ones. For the same sum, the player may purchase a sixth card, and the electronic device adds this card to the player's hand.

Players with a three-of-a-kind or higher can insure their bets in case of the absence of a playing combination in the electronic dealer's hand by placing an insurance sum that is within the parameters of the expected winnings of their bet. And if the electronic dealer doesn't have a playing combination, then instead of the payout of the initial bet, the electronic device pays the player winnings equal to the size of the insurance sum. If playing combination in the cards of the electronic dealer is weaker than that of the player, the insurance sum is lost.

If there isn't a playing combination in the hand of the electronic dealer, the players receive the initial bet or, paying their bet, exchange one of the electronic dealer's cards for a new one. If, in this case, the dealer still doesn't have a hand after the exchange, the electronic device doesn't pay out the bets.

The electronic device assesses the winning or losing bet, comparing the strength of the electronic dealer's and the player's card combinations. When the player wins, the electronic device pays out only the doubled wagers, corresponding to the strength of the winning combination after examining all the combinations in the player's hand, and pays out again in the case that there is a second playing combination that includes at least one card that was not included in the primary combination.

The electronic device conducts an accounting with the player at the end of every round of play, and the player may then finish the game or begin the game again. The device accompanies the game with sounds and video effects.

One possible construction of the “Russian Poker” electronic device allows for several players to play at once, with each of the players having their own display and control panel.

When using a monitor that reacts to touch, the following buttons on the monitor may be used to switch on the corresponding command: “Play”, “Bonus”, “Decrease”, “Increase”, “Cancel”, “Payout”, “Repeat”, “Exchange”, “Dealer's game”, “Bet”, “Insurance”, and “Refuse”. To exchange some of the cards from the player's hand or to purchase a sixth card, the player presses the image of the cards to be exchanged or purchased, and to cancel that decision presses the card a second time.

The representations and the invention's preferences have been drafted, with links to the accompanying figures, to illustrate the preferred variations of its embodiment:

FIG. 1 shows a casino game table for the application of the method of entertainment “Russian Poker”, including the use of a chip rack.

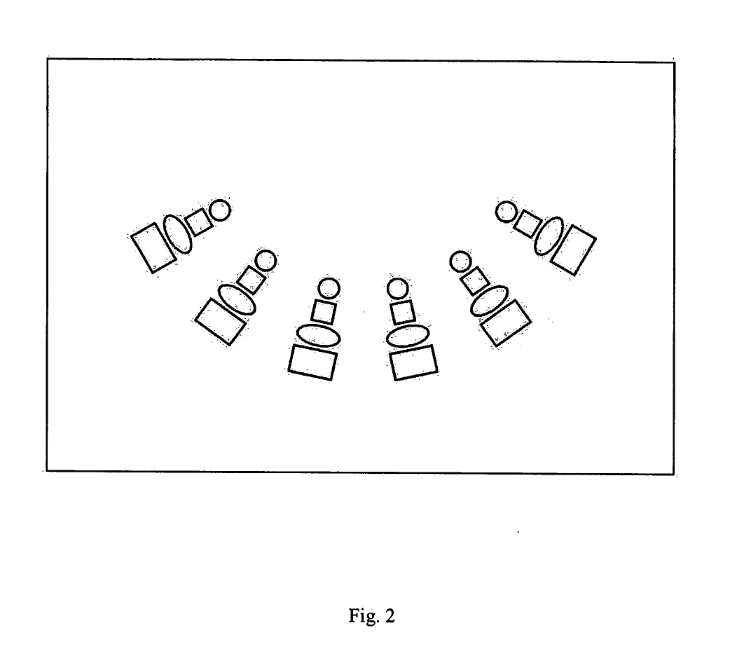

FIG. 2 shows a cloth cover of the casino table for “Russian Poker”, including the frames of the playing field and places for the players.

FIG. 3 shows a game table for “Russian Poker” for games the players play between themselves, when the casino isn't a part of the game.

FIG. 4 shows a coin-operated gaming machine “Russian Poker” that uses either paper or plastic cards.

FIG. 5 shows an electronic device with a monitor, using buttons that are activated by pressing a finger against their image on the screen.

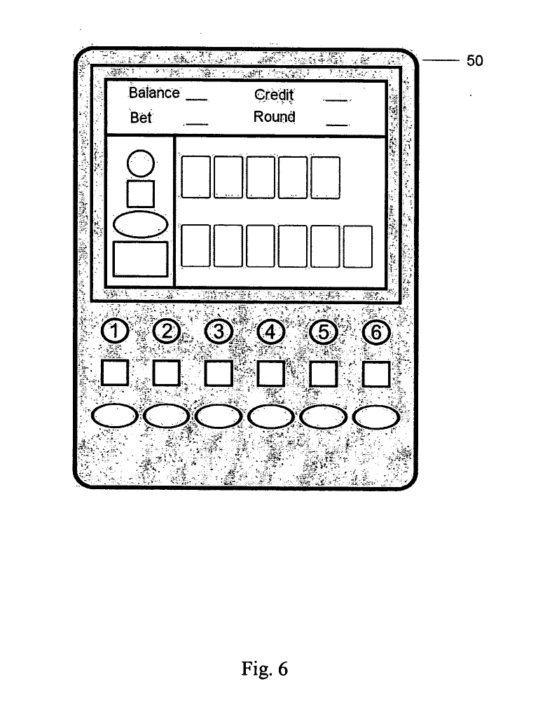

FIG. 6 shows a portable electronic device with a monitor for the realization of the method of entertainment “Russian Poker”.

FIG. 7 shows a scheme of the basic algorithm of the electronic method of entertainment “Russian Poker”.

FIG. 1 is an example of the use of the method of entertainment “Russian Poker” in a casino, where the game is conducted on a table similar to those used for Blackjack or Caribbean Poker, arranged in the form of a half-circle or polygon. The game table may be standard height for standard chairs, or a bit higher for the stools used in casinos when the dealer works standing up.

FIG. 2 is an image of the casino table cover with the outlines of one of the variations of the playing fields for realization of wagers, prepared for a semicircular card table.

The marked cover of the game table is stretched on specifically for that table, fortified with metal clamps and placed on a semicircular table. It may be made from cloth, wool, cotton, synthetic fabric, natural or synthetic leather, or other light industrial products. The coloring on the marked cover for the game table may produced by a variety of production methods.

The realization of the marked table cover allows for easily re-equipping a standard game table for the purpose of the method of entertainment “Russian Poker” and thereby allows the casino to broaden the opportunities available for its clients concerning game choice.

FIG. 3 is the image of the game table of “Russian Poker” for players playing amongst themselves, when the casino isn't a part of the game. Up to 6 people can play on this table. It is used when the gaming hall isn't taking part in the game and is only the game organizer. The dealer here is not part of the game; he enforces the rules of the game, collects a commission and may shuffle and deal the cards.

FIG. 4 is the image of the coin-operated “Russian Poker” gaming machine. It is the same size as other gaming machines. Its construction is intended to increase the comfort of players. The machine uses paper or plastic cards.

FIG. 5 is the image of the electronic device with the image of “Russian Poker's” playing field and the status bar that the player sees during the game. The monitor may be produced using Tough Screen technology, which uses switches activated not through keys but by pressing a finger against the screen on the image of the buttons.

FIG. 6 is a portable electronic device with a monitor that may be used in any place the player finds comfortable.

FIG. 7 is the image of the scheme of the basic algorithm that is used in the electronic device for the realization of the game “Russian Poker.”

The steps of data processing:

101. Initial position of the status bar.

102. The acceptance of the initial bet and a bet on the bonus.

103. The distribution of cards: six cards for the player and five cards for the dealer.

104. Settling payout for the bet on the bonus.

105. Exchange of one or several cards.

106. Exchange of the player's cards on the monitor, taking payment for the exchange.

107. Purchase of a sixth card for the player's hand.

108. Revealing the sixth card to the player, taking payment for the purchase.

109. Doubling the bet.

110. Showing the electronic dealer's cards.

111. The player's cards have three-of-a-kind or higher.

112. Accepting insurance (possibly equal to zero).

113. Showing the electronic dealer's cards.

114. Settling payout for insurance.

115. No playing combination in the electronic dealer's hand.

116. Playing combination in the player's hand.

117. Exchange of a card in the electronic dealer's hand.

118. Exchange of the highest card of the dealer's, taking payment for the exchange.

119. The dealer's new card and traded card are the same face value.

120. Final accounting and modification of the status bar.

121. Player continues to play.

122. Payout of the balance, end of game.

The method of entertainment's of the first embodiment (FIG. 1) uses a gaming table 1, a chip rack 2, a cover with the outline of the playing field as shown in FIG. 2, chips and a deck of cards, and the dealer, using a shuffled deck of cards, and a random combination in the player's hand reveals the winning or losing bet.

According to the first embodiment, the playing field contains the parameters of a playing area 3 for several players with parts for placing bets and for the cards, and also for playing on the bonus and for insurance. Every place for a player consists of four geometric FIGS. 4-7 that are located in direction away from the player and increase in size as they get closer to the player. The top circle 4 is for chips on insurance, the square below 5 is for bets on the bonus, the ellipse below that 6 is for the initial bet and the rectangle at the bottom 7 is for doubled bets and the player's cards.

All the players play against the casino, meaning against the casino's representative, the dealer. The purpose of the game is to collect a combination of cards in one's hand stronger than that of the dealer's. A standard deck of 52 cards, consisting of four suits of 13 cards each, is used the game “Russian Poker”. Each player may receive up to two hands of cards, however the bets on them must be equal. The minimum bet and the maximum payout for a winning combination is posted on a tablet on every table. There are no limits on the maximum bet.

The dealer shuffles the deck 2-3 times, cuts the deck and shuffles another 2-3 times. If the players so desire, a second deck may be used to save time while shuffling the cards. While one dealer conducts the game, another dealer or inspector shuffles the second deck.

The players make their initial bets, placing their chips on the ellipse. At the same time a player may bet that there will be a high playing combination, three-of-a-kind or higher, in his initial draw. To do this, the player places his chips on the square. That bet is called a bet on the bonus. The maximum payout for bets on the bonus is shown on the table's tablet. The size of the bet only on the bonus, placed on the square, excluding the initial sum, and the size of the maximum payout are equal to those for the initial bet on that table.

The dealer begins to deal the cards face-down, one per every player and himself, and continues until these hands have reached five cards each. The dealer also receives five cards, the last one of which is dealt face-up.

The player loses his bet on the bonus if there isn't a high playing combination in this initial draw. The bet on the bonus pays out when there is a combination of three-of-a-kind or higher in the players hand, regardless of the strength of the dealer's hand. The player should turn his cards over and, when the dealer sees that there is a combination of three-of-a-kind in the player's cards or higher, he pays out the winnings and returns the cards to the player.

The generally accepted playing combinations and payouts for bets on the bonus:

| | |
|---|---|
| Three-of-a-kind | 20:1 |
| Straight | 40:1 |
| Flush | 50:1 |
| Full House | 70:1 |
| Four-of-a-kind | 200:1 |
| Straight Flush | 500:1 |
| Royal Flush | 1000:1 |

The player can win a bonus, take his winnings from the square, and then continue the current round of the game. When the calculation of the bets on the bonus finish (if there were such bets), the dealer begins the card exchange. If the player doesn't see the prospect of winning in his cards, he returns the cards and the initial bet, located on the ellipse, and loses.

For a sum equal to the initial bet, players can exchange any number of their cards. For this, they place the cards selected to be exchanged on the square and, on them, chips equal to the sum of the initial bet.

The player can purchase a sixth card by placing chips equal to the sum of the initial bet on the circle. The dealer takes the chips from the circle and adds a sixth card to the player's hand and places a token marked with the number 6 on the circle, showing that the player already has six cards in his hand.

While the player has still not made a decision concerning the exchange of cards or the purchase of a sixth card in his first hand, he doesn't have the right to look at the cards in his second hand. If there aren't enough cards for the following exchange or purchase, the dealer, not taking the cards indicated for exchange, shuffles all the remaining disposed cards and continues the exchange.

If the player sees a winning prospect in his hand before or after the exchange, and decides to play, then he places his cards face down on the rectangle and makes a bet twice the size of the initial bet, placing the chips on his cards.

The player with a hand that has a high playing combination can only count on large winnings in the event that the dealer also has a playing combination. For that reason, it is desirable for a player with a three-of-a-kind or higher to insure his game in case of the absence of a playing combination on the part of the dealer. To do that, the player places the chips representing the insurance sum on the square. The size of that sum must be within the limits of the sum of the initial bet and the doubled bet of the player and the sum of the anticipated winnings.

During the players' card exchange, the dealer waits until all the players decide whether to double the bets or return their cards, losing the initial bet, as well as whether or not to insure their games from the absence of a playing hand in the dealer's hand. After the players' card exchange and the acceptance of insurance, the dealer shows his cards.

If the dealer shows his cards and there isn't a playing combination, the players' insurance pays out 1 to 1 for the chips placed on the square.

When the dealer doesn't have a playing combination, the players receive winnings equal to the initial bet, or pay their initial bet on the ellipse and the dealer exchanges the highest card in his hand for a new card from the deck. If the new card is the same value as the forfeited card, and the dealer still doesn't have a playing combination, the player may repeat the exchange for free. If, after the exchange, the dealer still doesn't have a playing combination, the initial bets do not pay out.

If there is a playing combination in the dealer's cards, the dealer first takes the insurance chips from the square of those players who insured their game and then turns over the players' cards in order, comparing his combination of cards with theirs. The dealer takes the bets of players who have weaker combinations than his, and pays out the bets of the players who have stronger combinations.

The generally accepted playing combinations, in order of their strength and the payouts for them:

| | |
|---|---|
| Ace-King | 1:1 |
| Pair | 1:1 |
| Two Pair | 2:1 |
| Three-of-a-kind | 3:1 |
| Straight | 4:1 |
| Flush | 5:1 |
| Full House | 7:1 |
| Four-of-a-kind | 20:1 |
| Straight Flush | 50:1 |
| Royal Flush | 100:1 |

When winning, the player's initial bet, placed on the ellipse, doesn't pay out; only the doubled bet, placed on the rectangle, pays out in proportion, according to the playing combination.

If, in addition to the winning combination, there is a second playing combination, it also pays out. The second combination must include a card that wasn't included in the primary combination.

When the player and the dealer have identical combinations, the winner is determined by the one with the higher cards. If the cards are equal, the game is a push.

The method of entertainment of the second embodiment exists with the help of a playing machine, in which a paper or plastic deck of cards is used.

The playing machine 10 for games in “Russian Poker” shown in FIG. 4 comprises the following parts and components:

an electronic machine;

a computer that directs the successive actions of the machine and corresponding bets, winning and losing;

a monitor 11 for displaying the balance and turn in the game;

a playing panel 19 with three rows of command keys 19-21;

a moving handrail as an armrest 22;

a token receiver, for paying for the game 17;

a bill validating machine 18 that takes in currency bills and determines the size, value and number;

a card-shuffling mechanism (not shown);

a card-dealing mechanism 13.

an optical and electronic counting system that can determine the suit and value of the cards (not shown);

a device for paying out tokens 24;

a device for paying out cash 23;

All the blocks, mechanisms and devices are located in the body of the machine that is the size of a standard gaming machine. The majority of the parts are already used in card games and machines, but their combination forming the machine is novel. However, the card-reading mechanism is novel.

For directing the corresponding command into the electronic device from the command panel, there are three rows of functional keys 19-21.

In the bottom row 21:

“Game”—for beginning the game and for pausing the game by pressing it again

“Bonus”—for placing a bet on the bonus, equal to the initial sum

“Decrease”—for decreasing the sum of the bet or insurance

“Increase”—for increasing the sum of the bet or insurance

“Cancel”—for canceling the last bet

“Payout”—for receiving the remaining balance

In the middle row 20:

“Repeat”—for repeating the bet from the previous round of the game

“Exchange”—for confirmation of the exchange of the cards chosen to the player

“Dealer's Game”—for exchanging the cards of the electronic dealer

“Bet”—for receiving the payout from the initial bet

“Insurance”—for insuring against the absence of a playing hand for the dealer

“Refuse”—for turning down an offer for insurance

In the top row 19 of the machine panel, there is a button under each card in the player's hand labeled from “1” to “5” for selecting the cards to be exchanged and a button with the number “6” for the purchase of a sixth card.

There is an arm rest 22 on the machine panel, below the keys, to be used during the game as an arm support, and it may be adjusted by several centimeters according to the player's preferences.

A status bar is located on the machine monitor 11, upon which the game's current balance is displayed, as well as the amount won or lost from the start of play and the number of rounds played. The bets placed by the player are represented on the image of the four FIG. 12—a circle, a square an ellipse and a rectangle. The monitor illuminates the best playing combination or two combinations at every move in the game, for the player's information.

The game is conducted according to the rules used in “Russian Poker” for casinos, and is controlled according to the basic algorithm of the game (FIG. 7).

There are two rows of bins, one for the player's hand 16 (six bins) and one for the machine 14 (five bins), behind the glass screen of the machine, located in the most convenient place for the player to observe the game moves. A special mechanism shuffles the cards and places five of them in the lower tray 15, for the player's cards. The tray 15 is built slightly larger than the size of a card and moves with the help of a direction belt, similar to the flow of a printer moving an ink cartridge. The tray 15 distributes face-up cards to the player's five bins 14. The machine hand is placed in the upper tray 13, but the cards are not exposed in the bins 14. The player can see the top card of the five meant for the machine. If the player makes an exchange or buys a sixth card, he presses the corresponding keys on the machine panel, and the new cards are dealt from the distributing mechanism, placed in the player's tray 15 and from there lowered into those bins in which the cards the player indicated are located. The old cards are covered by the new cards.

When the player has made all the decisions in this turn of the game, the machine card-reading mechanism places the cards in the bins 14 for the machine hand with the help of the top tray 13.

An optical system that can determine the suit and face value of the cards compares the two hands, the computer determines the winner and, if it is the player, pays out his winnings and changes information on the status bar 11.

If the player wants to finish the game, in order to receive his remaining money and winnings, he presses the “Payout” button. The player receives tokens or money, depending on which he has been playing with.

The game is accompanied by musical and video effects.

A possible construction of the “Russian Poker” machine includes a playing field that consists of several places for players. In this type of multi-place machine several players can play at once. Each player has his own monitor and control keys. The playing combinations in the hands of the players are compared only with the combination in the machine hand.

The method of entertainment of the third embodiment uses an electronic device 30 with a monitor (FIG. 5), in which:

the management, data analysis and the fulfillment of user commands take place with the help of a computer program written on a readable disk,

the introduction of information into the electronic device is realized by, at a minimum, one means of transfer,

a random number generator is used,

an electronic deck of playing cards is used,

an image of an electronic playing field is formulated on the monitor,

chips or collected points are reflected on the game field,

the game is guided by the basic algorithm (FIG. 7).

The game's objective is for the player's combination to be stronger than the electronic dealer's. The minimum bet and maximum payout are posted on the game. There is no limit to maximum bets.

The player makes bets using the buttons, and the electronic device displays two random hands of cards on the monitor. The winning or losing bet is determined by the combinations of cards, and whether the best playing combination is in the player's hand 36 or in the dealer's 33.

There are three rows of functional buttons 39-41 to conduct the corresponding commands from the command panel into the electronic device.

In the bottom row 41:

“Game”—for beginning the game and for pausing the game by pressing it again

“Bonus”—for placing a bet on the bonus, equal to the initial sum

“Decrease”—for decreasing the sum of the bet or insurance

“Increase”—for increasing the sum of the bet or insurance

“Cancel”—for canceling the last bet

“Payout”—for receiving the remaining balance

In the middle row 40:

“Repeat”—for repeating the bet from the previous round of the game

“Exchange”—for confirmation of the exchange of the cards chosen to the player

“Dealer's Game”—for exchanging the cards of the electronic dealer

“Bet”—for receiving the payout from the initial bet

“Insurance”—for insuring against the absence of a playing hand for the dealer

“Refuse”—for turning down an offer for insurance

In the top row 39 of the machine panel, there is a button under each card in the player's hand labeled from “1” to “5” for selecting the cards to be exchanged and a button with the number “6” for the purchase of a sixth card.

The electronic device formulates the image of the four FIG. 32—a circle, a square an ellipse and a rectangle. The bets placed by the player are represented on these figures.

The player chooses the sum of his initial bet using the “Decrease” or “Increase” buttons. The player can also make a bet on the bonus, betting that he will be dealt a high playing combination, from three-of-a-kind to a royal flush, in the initial deal. If the player doesn't continue after receiving his cards or if he exchanges his cards, the bonus is lost. The bet on the bonus pays out when there is a combination of three-of-a-kind or higher in the player's hand upon receipt, regardless of the hand that the electronic dealer has.

The electronic dealer collects the player's bet on the bonus if the player doesn't have a high combination. And if there is one, the bonus combination is paid out according to its strength.

The generally accepted playing combinations and payouts for bets on the bonus:

| | |
|---|---|
| Three-of-a-kind | 20:1 |
| Straight | 40:1 |
| Flush | 50:1 |
| Full House | 70:1 |
| Four-of-a-kind | 200:1 |
| Straight Flush | 500:1 |
| Royal Flush | 1000:1 |

The player can win the bonus, take his winnings, exchange some of his cards for a sum equal to the initial bet and continue the current round of the game.

If the player doesn't see a prospect for winning in his cards and doesn't play, he loses his initial bet. For a sum equal to the initial bet the player may exchange any amount of cards or purchase a sixth card. If the player decides to play, he makes a second bet twice the size of the initial bet. The electronic dealer shows his cards. If the dealer doesn't have a game, the initial bet is paid one-to-one.

A player with three-of-a-kind or higher can insure himself against the case that the electronic dealer doesn't have a playing combination by placing the insurance sum within the limits from the sum of his bet up to the expected winnings. If the dealer's cards have a playing combination, the insurance sum is lost. If the dealer doesn't have a game, then the player receives winnings equal to the size of the insurance sum, in addition to the payout for the initial bet.

When the dealer doesn't have a game, the player can receive winnings equal to the initial bet or, paying his initial sum, exchange an old card of the dealer's for a new one. If the new card turns out to be the same value as the exchanged one, the player can repeat the exchange for free. If the dealer still doesn't have a playing combination after the exchange, there isn't a payout for the initial sum.

If the dealer's cards have a playing combination, then they are compared to the player's combination of cards. The electronic dealer takes the player's bet if the player has a weaker combination then he does, and pays the bet when the player's cards have a stronger combination. Only doubled bets are paid out in proportion, depending on the generally known playing combinations:

| | |
|---|---|
| Ace-King | 1:1 |
| Pair | 1:1 |
| Two Pair | 2:1 |
| Three-of-a-kind | 3:1 |
| Straight | 4:1 |
| Flush | 5:1 |
| Full House | 7:1 |
| Four-of-a-kind | 20:1 |
| Straight Flush | 50:1 |
| Royal Flush | 100:1 |

If in the player's hand there is, in addition to the winning combination, a second playing combination that wasn't included in the primary combination, it also pays. The second combination must include at least one card that wasn't included in the primary hand. There can't be a third combination.

When the player and the electronic dealer have identical combinations, the winner is determined by who has higher cards. If all the cards have the same value, the game is a push.

The game is accompanied by sound and video effects.

The computer game “Russian Poker” exists with the help of a computer system that computes the data, a monitor, and a means of conducting information from the user into the system. Any computer system or another secure apparatus that includes a monitor can be used for the computer game “Russian Poker”. The algorithm of the game is based on the terms of the method of entertainment “Russian Poker”, and it contains a programming safeguard, written in a programming language. The program is saved on a compact disk or different type of data holder.

The preferred variant of the embodiment of the game is a computer program, saved on a compact disk, and compatible with a home computer. For example, an optimal computer for “Russian Poker” includes a motherboard with a Pentium processor, at least 1 megabit of RAM, a hard drive with several gigabits, a sound card and color monitor.

An image of the playing field, the functional buttons and the chips for placing bets are projected onto the monitor. An electronic deck of 52 cards is used for the game.

The rules and sequence of action in the method of entertainment “Russian Poker” for the computer is analogous to those of the gaming machine.

The size of the bet is determined by using the keys on a standard keyboard. The player chooses the cards for exchange using either the keys that correspond with the card on the monitor or the mouse. The player uses commands that are activated from the image of buttons on the monitor. A status bar is located on the monitor that shows the current balance of the game, as well as the sum won or lost from the beginning of the game and the results of both the previous round and current round. The game is accompanied by sound and video effects.

The method of entertainment “Russian Poker” which can be played at an internet casino or at a local set is the same as on a computer, with the one difference that at the internet casino and the local set several players can play together at the same time, for real or virtual money. In this case, a directing program for a casino server or a client program for remote computers is used. The playing field is formulated on the player's computer monitor with the client program and, at an internet casino, the player's balance is formulated on the status bar, in accordance to the size of the player's account.

If “Russian Poker” is realized with the help of a mobile electronic device 50 (shown in FIG. 6), then the program may be saved with the help of SBIS microcircuit, built into the device or on a PC Card, and read by the device. Using a mobile electronic device with a program saved on a SPIS microcircuit or memory card, it is possible to play in any place, including transportation systems. It is possible to have real payouts when winning, if the organizers of the game pay the player's winnings in agreement with the collected sum, fixed in the player's balance on the screen of his electronic game and saved in the memory microchip.

One of the effective realizations of the game “Russian Poker” is connected with the building of an electronic playing machine 30 with an electronic-radial pipe or liquid crystal screen.

The game is accompanied by video and sound effects. In the process of each round, the bets appear on the screen, represented in four geometric figures 32, same as the player's cards 34 and the dealer's cards 33. On the monitor, under the player's cards, three rows of control buttons 36 are shown, with the name of the function on each button. The buttons that can be used at a given moment of the game become brighter, helping the player make this or that decision while playing.

The player makes his decision, pressing one of the keys located in the three rows under the monitor 39-41. Each key has its own number or name. If the machine display utilizes Tough Screen technology, the command buttons can be turned on by pressing a finger against the screen, meaning that the command buttons can be activated by pressing on their image.

There is a status bar 31 on the monitor of the machine in which the main parameters of the game are posted:

the current financial means of the player (his credit);

the sum won or lost from the beginning of the game;

the number of the current round;

the amount of bets on the current round; and

the results of the current round.

The bet in the current round includes two fields: the initial bet on the ellipse and the doubled bet on the rectangle. The result of the current round is at first equal to zero, and during the process of the round may become negative when the payment for the purchase or exchange of cards is taken from the player or for the exchange of one of the electronic dealer's cards. If the player purchases insurance during the round, the money won or lost from this sum will also show in the result of the current round. The final value of this parameter is formulated when the dealer's cards are reckoned, at the every end of the round.

The scenario that plays out in the round looks like the following example. At the beginning of the round, the player makes his initial bet and presses the button “Play”. The player's five face-up cards appear on the monitor, as does a sixth, face-down card and the dealer's cards—one face up and the rest face down. The face-up cards of the player are ordered: they are placed left to right in order of their value. If, for example, the player has a pair, then those cards making up the pair are placed on the left (as the most valuable). If the player has a Full House, those cards that make up the three-of-a-kind are placed on the left and the cards that make up the pair are placed on the right. The name of the corresponding playing combination or two combinations is illuminated next to the player's cards.

There is a command button for every open card of the player's, used to exchange the corresponding card. In the center of the player's sixth card there is the same kind of a button. It is used to turn that card over (to purchase the sixth card, in other words). In addition to that, two other buttons are activated on the screen at this moment: “Reject” and “Bet”. By using these buttons, the player can choose one of the decisions: stop playing the game and lose the initial bet, or exchange any of his cards or turn over the sixth card.

The development of the game after the doubling of the bet is dealt with below, and if the player turns down the game, then the dealer's cards are turned over and the round is quickly concluded. If the player exchanges cards, then the corresponding exchange takes place on the monitor: the used cards are exchanged, the cards are subsequently placed in order again, and next to the cards the name of the new combination (or two combinations) appears. In addition to that, the payment for the card exchange is taken from the player, and it is quickly displayed on the status bar. The analogous action takes place in situations where a sixth card is purchased: the sixth card is turned over and after filing the sixth card in its place, the “extra” card, which doesn't enter into the best five card combination, is moved to the space where the sixth card once was.

After the purchase/exchange of the card, two active control buttons remain on the monitor: “Reject” and “Bet”. The player again has to make a choice. “Reject”, like before, brings about the end of the round.

If the player doubled his bet, then he may be inclined to buy insurance.

The command button “Insurance” is activated when the player has a combination of three-of-a-kind or higher. The player has the right to make a new bet—insurance—within the limits defined by the rules (or he can decide against insurance by pressing the button “Reject”), and then continue the game with the help of the button “Play”.

After that, the dealer's four face-down cards are turned over. All five of the dealer's cards are ordered and next to them the name of the dealer's playing combination appears. If the player insured himself, then it is determined whether the insurance won or lost before anything else. The result of the game on this bet is quickly posted on the status bar.

If there is a playing combination in the electronic dealer's hand, then the final accounting takes place, the status bar is updated and the round is over. This same action takes place in the situation in which neither the dealer nor the player has a valued combination.

If the electronic dealer doesn't have a playing combination, and the player does have one, then two control buttons are activated: “Initial Bet” and “Dealer's Game”. The player may choose one of the two possible selections. If he picks “Initial Bet”, then he wins a sum equal to the initial bet and the round is over.

If the player chooses the button “Dealer's Game”, then payment is taken from the player to exchange the highest card of the dealer's for a new card. If the new card is the same value as the old one and the dealer doesn't have a combination, the player can repeat the exchange. After this, the cards of the electronic dealer are re-ordered and the name of his new playing combination appears next to them. After that the final accounting takes place (depending on dealer's and player's combinations), the corresponding changes are posted on the status bar and the round is finished.

A new round begins if the player wishes to continue the game.

If the player wants to end the game, he presses “Payout” and receives the remainder of his money and winnings.

One possible construction of the gaming machine “Russian Poker” allows for several players to play at once. Each player has a display and his own control keys. The playing combinations in the electronic hand of cards are compared with the machine hand of cards alone.

The present description consists of concrete examples for the realization of the invention with the help of a playing table, a gaming machine and an electronic device with a monitor; however, they do not include all the possible variations of realizing the method of entertainment “Russian Poker” that fall under coverage of the protection for the definite claim scope of the invention.

1. A method of entertainment comprising a card game played on a game table with a rack for a set of chips, a table cover with an outline of a playing field, and decks of cards, comprising the following steps:
at least one player making an initial bet, using chips representing monetary bets, in order to receive a hand of five cards;
a dealer shuffling and dealing cards to the players and to himself;
the player paying a sum equal to the initial bet in order to exchange up to five cards;
the player placing chips equal to the initial bet on the table in order to purchase a sixth card;
the dealer comparing combinations of cards held by the players and by the dealer and determining winning and losing bets; and
the dealer paying out the winning bets depending on the combination of cards;
wherein,
if the player has more then one playing combination, the dealer plays out for them as well;
if the dealer does not have a playing combination, the player receives the initial bet or, in exchange of a sum equal to his initial bet, one of dealer's cards; and
if the player wins, the payout of winnings to the player consists of chips equal to a double bet considering all possible developments of playing combinations in player's hands, in proportion to corresponding strength of combinations on posted payouts.

2. The method according to claim 1, wherein a minimum bet size and a maximum payout size for winning are posted on the game table, and the maximum bet is not limited.

3. The method according to claim 1, wherein the players place chips representing the initial bet on the table in order to receive a hand of five cards.

4. The method according to claim 1, wherein the table cover has place marks for the players, each comprising four following geometrical figures:
a circle for placement of chips for the purchase of a sixth card and for a token with a number “6”;
a square for bets placed on a bonus, for exchange and for insurance chips;
an ellipse for initial bets; and
a rectangle for player's cards and for doubling of bets.

5. The method according to claim 1, wherein the game uses two decks of cards, each of 52 cards, including 4 suits with 13 cards in each suit.

6. The method according to claim 1, wherein the deck of cards is shuffled 2-3 times, cut and shuffled another 2-3 times, at which point the deck is handed to the player to be cut again.

7. The method according to claim 1, wherein the cards which are no longer in use in the game are shuffled whenever there are not enough cards for a next exchange, and the next exchange is continued with said cards.

8. The method according to claim 1, wherein one player may play in two places, making two squares for playing on a bonus and/or two equal initial bets on the ellipses, receiving two hands of five cards each.

9. The method according to claim 1, wherein a bet on a bonus pays out when the player's hand consists of a high playing combination, regardless of the combination in the dealer's hand.

10. The method according to claim 1, wherein, when playing a game on a bonus, the player receiving bonus chips may exchange up to five cards, or buy a sixth card for a winning bonus equal to the initial bet.

11. The method according to claim 1, wherein the player must make his decision about the exchange of cards from a first selection before looking at cards from a second selection.

12. The method according to claim 1, wherein the player purchases insurance against the loss of a high playing combination in absence of a playing combination in the dealer's hand, in which the insurance sum consists of a number of chips within the limits of his potential winning, and the insurance sum is paid in addition to the initial bet.

13. The method according to claim 1, wherein, when the dealer has a playing combination and it is weaker than the player's combination, the player loses the insurance sum; if the dealer's combination is stronger than the player's, then the insurance sum is returned to the player.

14. The method according to claim 1, wherein, if after the exchange the dealer still does not have a playing combination, there is no return or payout of the initial bet.

15. The method according to claim 1, wherein, if the new card has the same value as the card which was exchanged, and the dealer doesn't receive a playing combination, the player may repeat the exchange.

16. The method according to claim 1, wherein, if the dealer's cards became stronger than those of the player's after the exchange, the player loses only the doubled bet.

17. The method according to claim 1, wherein, if there is a second playing combination in the player's hand, with at least one card not included in main winning combination, the dealer pays out for the second combination.

18. The method according to claim 1, wherein in a single hand of the player's, no more than two playing combinations may pay out.

19. The method according to claim 1, wherein a casino is not a party in the game, and the dealer only shuffles and deals the cards, enforces the rules and collects a commission.

20. The method according to claim 1, wherein the dealer may be one of the players.

21. A gaming machine for entertainment, comprising:
a computer;
a game program;
a control panel with functional keys that introduce commands;
a display to reflect a balance and a number of turns in a game;
a slot for receiving, authenticating and calculating money;
a bin for payouts;
a shuffle mechanism to shuffle at least one deck of cards, with 52 cards of four suits, with each suit having 13 cards, and to secure a random position of the cards; and
a card-distributing mechanism movable by a belt, which includes two trays for dealing the cards into a player's hand and into a machine hand, and for exchange by directing and dealing face-up one card at a time;
wherein the computer, using the game program, determines a winning hand and either collects player's bet or gives a command to pay off, and indicates a change in player's data on the display; and
when a player wins, the machine pays only a doubled bet in proportion to corresponding strength of a winning combination and a table of payouts.

22. The gaming machine according to claim 21, wherein two decks of 52 cards of four suits, with each suit having 13 cards are used and, while the player is playing a game, the machine shuffles a second deck.

23. The gaming machine according to claim 21, wherein a minimum bet and a maximum payout for a winning combination are posted, and a maximum bet is unlimited.

24. The gaming machine according to claim 21, wherein there are two rows of bins behind a transparent screen, each bin being a size of a card, with top row consisting of five bins for a machine hand and a lower row consisting of six bins for a player's hand.

25. The gaming machine according to claim 24, wherein, when moving in the direction of a first tray the mechanism places face-up cards one at a time in five of the six lower bins for the player's hand.

26. The gaming machine according to claim 25, wherein, by pressing corresponding buttons on the control panel, the player determines which card or cards to be exchanged, and then presses a key “Exchange” on the control panel, and, upon payment of an initial bet, the distributing mechanism places new cards from the shuffle mechanism into the first tray and then into the bins, covering over cards selected by the player to be exchanged.

27. The gaming machine according to claim 26, wherein, by pressing the sixth button, the player purchases a sixth card for a price of the initial bet, and the sixth card is placed in the first tray and then into an empty sixth bin.

28. The gaming machine according to claim 26, wherein after the player makes a decision about his hand of cards, the distributing mechanism places the cards in a second tray face-up in the five bins of the top row, signifying the machine's hand of cards.

29. The gaming machine according to claim 24, wherein an optical and logical system to determine suit and value of cards for comparing the hands in the top and bottom rows.

30. The gaming machine according to claim 21, wherein the control panel comprises three rows of functional keys to introduce corresponding commands to the gaming machine, with a bottom row containing: “Play”, “Bonus”, “Decrease”, “Increase”, “Cancel”, and “Payout”; a middle row containing: “Repeat”, “Exchange”, “Dealer's Game”, “Bet”, “Insurance”, and “Refuse”; and a top row containing five buttons under each card in a player's hand for exchange of player's cards, and a sixth button with a number “6” for purchase of a sixth card.

31. The gaming machine according to claim 21, comprising a panel beneath the keyboard with an adjustable metal armrest for player's comfort.

32. The gaming machine according to claim 21, wherein the display shows a status bar with a sum of credit, a balance for a game and results of both a previous round and a current round of the game.

33. The gaming machine according to claim 21, wherein the display shows a highest playing combination or combinations after each move of the game.

34. The gaming machine according to claim 21, wherein the machine pays out bets on a bonus when a player's initial hand includes a high combination of cards, regardless of selection of cards in the machine hand.

35. The gaming machine according to claim 21, wherein the machine exchanges up to 5 of the player's cards for a sum equal to the initial bet.

36. The gaming machine according to claim 21, wherein for a sum equal to the initial bet a sixth card can be added to the player's five cards.

37. The gaming machine according to claim 21, wherein a player can insure himself against an absence of a playing combination in the machine hand, given that an insurance sum is not higher than a player's potential winnings, and wherein the machine pays the player an insurance sum if the machine hand has no playing combination and, if the machine has a playing combination, the insurance sum is lost.

38. The gaming machine to claim 21, wherein, if a player has a high playing combination in absence of a playing combination in the machine hand, the player pays his initial bet for an exchange of one of cards in the machine hand for a new card.

39. The gaming machine according to claim 21, wherein when the player's winnings are paid and there is a second combination in his hand that includes at least one card not included in a first winning combination, the second combination also pays out.

40. The gaming machine according to claim 21, wherein several players can play at once, in which case each player has his own display and control keys, and the machine compares playing combinations in the players' hands only with the machine hand.

41. An electronic device with a monitor, comprising:
an electrical circuit;
a random number generator;
a computer for interpreting a series of commands using a controlling program and for calculating corresponding winning and losing bets;
a monitor for displaying a game board and a player's balance;
a control panel with functional keys for introducing said commands;
a slot for receiving, authenticating and calculating money;
a bin for payouts; and
a tablet posting the payouts;
wherein the electronic device, using a gaming program and the random number generator, creates and displays on the monitor an image of two hands of cards, representing a player's hand and an electronic dealer's hand, and
wherein, upon payment of an initial bet, the player exchanges up to five of his cards or buys a sixth card, and the electronic device exchanges cards selected by the player for different ones or adds a sixth card to the player's hand;
if there isn't a playing combination in the electronic dealer's hand, for a sum equal to the initial bet, the electronic device exchanges the lowest card in the electronic dealer's hand for a new card,
the computer determines a winning or losing bet, comparing the card combination of the electronic dealer with that of a player, and, when the player wins, the electronic device pays out only a doubled bet, corresponding with a strength of a primary winning combination, then examines all occurring combinations in the player's hand and pays out for any additional playing combination that includes at least one card not used in the primary winning combination.

42. The electronic device according to claim 41, comprising a display of a minimum bet and a maximum payout for a winning combination, with an unlimited maximum bet.

43. The electronic device according to claim 41, wherein during each turn of a game the electronic device forms on the monitor a status bar representing player's standing, which shows a current balance of the game, as well as a total sum won or lost by the player during the game and results of both last and current rounds.

44. The electronic device according to claim 41, wherein the electronic device, after paying the player his winning bonus during the game on a bonus, allows the player for a sum equal to his initial bet to exchange up to five of his cards or to purchase a sixth card.

45. The electronic device according to claim 41, wherein a player with a high playing combination can insure his bet against an absence of a playing combination on a part of the electronic dealer by wagering an insurance sum within limits of his expected winnings.

46. The electronic device according to claim 45, wherein if there is no playing combination in the electronic dealer's hand, the electronic device pays the player the insurance sum, and the insurance sum is lost if the electronic dealer has a playing combination.

47. The electronic device according to claim 46, wherein any additional playing combination must include at least one card that is not included in the primary winning combination.

48. The electronic device according to claim 41, wherein, when the monitor reacts to a touch, the commands are introduced by an image of corresponding buttons on the monitor.

49. The electronic device according to claim 41, wherein several players play at once on the electronic device and each of them has a personal display and a control panel.

50. The electronic device according to claim 41, wherein the game includes several electronic devices with monitors connected in a network with a controlling server.
